(19) United States
(12) Patent Application Publication
(10) Pub. No.: US 2015/0344364 A1
(43) Pub. Date: Dec. 3, 2015

(54) PROCESS FOR PREPARING A MOF SHAPED WITH A HYDRAULIC BINDER BY LIQUID-FREE PELLETING OR BY GRANULATION, HAVING IMPROVED MECHANICAL PROPERTIES

(71) Applicant: IFP ENERGIES NOUVELLES, Rueil-Malmaison Cedex (FR)

(72) Inventors: Delphine BAZER-BACHI, Irigny (FR); Bogdan HARBUZARU, Valencia-Espagne (FR); Eric LECOLIER, Chaville (FR)

(73) Assignee: IFP ENERGIES NOUVELLES, Rueil-Malmaison Cedex (FR)

(21) Appl. No.: 14/427,708

(22) PCT Filed: Sep. 6, 2013
(86) PCT No.: PCT/FR2013/052053

§ 371 Date: Mar. 12, 2015

(30) Foreign Application Priority Data
Sep. 12, 2012 (FR) 12/02430

(51) Int. Cl. C04B 7/32; C04B 7/02

(52) U.S. Cl. CPC C04B 7/32; C04B 7/02

(57) ABSTRACT

The invention relates to a process for preparing a novel material comprising at least one crystalline organic-inorganic hybrid material (MHOIC) formed with a binding formulation comprising at least one hydraulic binder, said process comprising at least one step of mixing at least one powder of at least one crystalline organic-inorganic hybrid material with at least one powder of at least one hydraulic binder in the absence of solvent, followed by a step of forming, preferably by pelletizing in the absence of solvent or by granulation, the mixture obtained at the end of the mixing step.

The present invention relates to the field of crystalline organic-inorganic hybrid materials (COIHM) and, in particular, to their shaping with a view to their use in industrial applications for catalysis, storage of gas for example, or separation. More specifically this invention relates to a process for preparing a novel material comprising at least one crystalline organic-inorganic hybrid material (COIHM) shaped with a binding formulation comprising at least one hydraulic binder, the said process comprising at least one stage of mixing at least one powder of at least one crystalline organic-inorganic hybrid material with at least one powder of at least one hydraulic binder in the absence of solvent, followed by a step of shaping, preferably by granulation or pelleting in the absence of solvent, the mixture obtained at the end of the mixing step.

### PRIOR ART

Throughout the following text the term crystalline organic-inorganic hybrid materials (COIHM) is understood to mean any crystalline material containing organic and inorganic entities (atoms, clusters) joined by chemical bonds. Among this class of material there may be mentioned, though without being exhaustive, MOF (Metal Organic Framework), co-ordination polymers, ZIFs (or Zeolitic Imidazolate Frameworks), MILs (or lnstitut Lavoisier materials), and IRMOFs (or IsoReticular Metal Organic Framework).

The said crystalline organic-inorganic hybrid materials (COIHM) were described together with the first examples in the 1960s, and are the subject of an increasing number of publications. The great interest in these materials has enabled a high degree of structural diversity to be achieved in a short time (Férey G., l'Actualité Chimique, January 2007, No. 304). Conceptually, the said porous hybrid materials having a mixed organic-inorganic die (COIHM) are fairly similar to porous materials having an inorganic skeleton. Like the latter, they combine chemical entities, giving rise to porosity. The main difference is in the nature of these entities. This difference is particularly advantageous and is the origin of the whole versatility of this category of hybrid materials. In fact, the size of the pores can be adjusted, via the use of organic ligands, by altering the length of the carbon chain of the said organic ligands. The framework, which in the case of inorganic porous materials can only accept certain elements (Si, Al, Ge, Ga, P and possibly Zn) may, in this case, accept all cations. No specific structuring agent is required to prepare these hybrid materials, and the solvent itself plays this role. It can therefore clearly be seen that this family of crystalline organic-inorganic hybrid materials allows a multiplicity of structures and, consequently, includes solids that are extremely well adapted to their intended applications.

The crystalline organic-inorganic hybrid materials (COIHM) comprise at least two so-called connector elements and ligands whose orientation and number of binding sites are decisive in the structure of the said hybrid material. The diversity of these ligands and connectors gives rise, as has already been mentioned, to a huge variety of hybrid materials.

The term ligand denotes the organic part of the said hybrid material. These ligands are most commonly di- or tricarboxylates or nitrogen-containing derivatives or pyridine. Some commonly encountered organic ligands are shown hereinafter: bdc=benzene-1,4-dicarboxylate, btc=benzene-1,3,5-tricarboxylate, ndc=naphthalene-2,6-dicarboxylate, bpy=4,4′-bipyridine, hfipbb=4,4′-(hexafluororisopropylidene)-dibenzoate, cyclam=1,4,8,11-tetraazacyclotetradecane, imz=imidazolates.

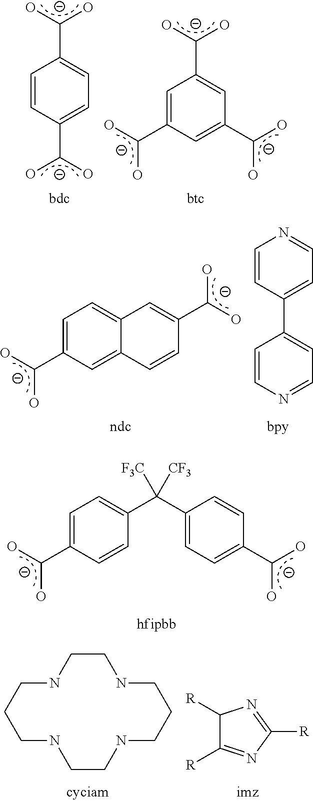

The term connector denotes the inorganic entity of the said hybrid material. It may be a single cation, a dimer, trimer or tetramer, or also a chain or a planar structure.

The Yaghi and Férey research groups have thus described a large number of new hybrid materials (MOF—“Metal Organic Framework” series, and MIL—“Institut Lavoisier materials” respectively). Numerous other research groups have followed this path and nowadays the number of described new hybrid materials is increasing at a fast rate. Most often the investigations are aimed at developing ordered structures having extremely large pore volumes, a good thermal stability and adjustable chemical functionalities.

For example, Yaghi et al. describe a series of boron-based structures in US patent application 2006/0154807 and mention their usefulness in the field of gas storage. U.S. Pat. No. 7,202,385 discloses a particularly comprehensive overview of the structures described in the literature and illustrates perfectly the large number of existing hybrid materials up to the present.

The synthesis of crystalline organic-inorganic hybrid materials (COIHM) is particularly well documented both in the patent literature and non-patent literature. However, these powders have to be shaped so that they can be used in industrial applications, and in this respect there are few available references, as has been pointed out by Tagliabue et al. The shaping of crystalline organic-inorganic hybrid materials (COIHM) is generally achieved by a compaction process: either by direct compression (Tagliabue et al. Methane storage on CPO-27 pellets, J. Porous Mater (2011) 18, 289-296), or by adding polymer binders (Finsy et al., Separation of CO₂/CH₄ mixtures with the MIL53 (Al) metal-organic framework. Microporous and mesoporous materials, 120 (2009) 221-227), or, more rarely, by adding an alumina or carbon blacks (Cavenati et al., Metal organic framework adsorbent for biogas upgrading, Ind. Eng. Chem. Res. 2008, 47, (6333-6335).

However, this type of shaping is unsuitable for applications in the presence of water or with liquid reactants/products. In these cases the mechanical strength conferred by soluble polymer binders cannot withstand long periods of industrial use. Likewise, in the case of direct compression without a binder the capillary forces and the penetration of solvents can lead to the destruction of the material and the production of fines, with disastrous consequences for the process.

An object of the present invention is to provide a process for preparing a new material comprising at least one crystalline organic-inorganic hybrid material (COIHM) shaped with a binding formulation comprising at least one hydraulic binder, preferably by granulation or pelleting in the absence of solvent, the said material obtained having improved mechanical properties, particularly in terms of mechanical strength, and also able to withstand a rise in temperature compatible with the crystalline organic-inorganic hybrid material (COIHM).

Another object of the present invention is to provide a process for preparing the said material, the said material obtained having a good mechanical strength and being suitable for use in the presence of a solvent and therefore in an industrial process over long periods.

### OUTLINE OF THE INVENTION

The present invention relates to a process for preparing a material comprising at least the following steps:

a) a step of mixing at least one powder of at least one crystalline organic-inorganic hybrid material (COIHM) with at least one powder of at least one hydraulic binder to obtain a mixture, the said mixing step being carried out in the absence of solvent,
b) a step of shaping the mixture obtained at the end of the step a).

An advantage of the present invention is to provide a process of preparation that enables a material to be obtained comprising at least one crystalline organic-inorganic hybrid material (COIHM) shaped with a binding formulation comprising at least one hydraulic binder, the said material having improved mechanical properties, in particular in terms of mechanical strength, and able to withstand a rise in temperature, which enables the said material to be employed in processes in the presence of water or solvents and at relatively high temperatures but nevertheless restricted by the temperature behaviour of the crystalline organic-inorganic hybrid material (COIHM).

Another advantage of the present invention is to provide a unique process for preparing the said material according to the invention, which can be employed regardless of the content of crystalline organic-inorganic hybrid material (COIHM), the said process enabling materials to be obtained having a good mechanical strength and therefore capable of being used in a fixed bed.

### DETAILED DESCRIPTION

In accordance with the invention the process for preparing the material comprises at least the following steps:

a) a step of mixing at least one powder of at least one crystalline organic-inorganic hybrid material (COIHM) with at least one powder of at least one hydraulic binder to obtain a mixture, the said mixing step being carried out in the absence of solvent,
b) a step of shaping the mixture obtained at the end of the step a).

### Step a):

The said crystalline organic-inorganic hybrid material or materials (COIHM) used in the material according to the present invention are preferably selected from MOF (Metal Organic Framework), ZIFs (or Zeolitic Imidazolate Frameworks), MILs (or Institut Lavoisier materials) and IRMOFs (or IsoReticular Metal Organic Frameworks), individually or as a mixture. Preferably the said crystalline organic-inorganic hybrid material or materials (COIHM) used in the material according to the present invention are selected from the following list: SIM-1, HKUST, CAU-1, MOF-5, MOF-38, MOF-305, MOF-37, MOF-12, IRMOF-2 to -16, MIL-53, MIL-68, MIL-101, ZIF-8, ZIF-11, ZIF-67, ZIF-90.

The said crystalline organic-inorganic hybrid material or materials (COIHM) are used in the step a) of the preparation process according to the invention in the form of a powder.

The said hydraulic binder or binders mixed in the form of powder with at least one powder of at least one crystalline organic-inorganic hybrid material is/are advantageously selected from hydraulic binders well known to the person skilled in the art. Preferably, the said hydraulic binder or binders is/are selected from Portland cement, aluminous cements such as for example molten cement, Ternal, SECAR 51, SECAR 71, SECAR 80, sulfoaluminous cements, plaster, cements with phosphate bonds, such as for example phospho-magnesia cement, blast furnace slag cements and mineral phases selected from alite (Ca₃SiO₅), belite (Ca₂SiO₄), alumino-ferrite (or brownmillerite: semi-formula Ca₂ (Al,Fe³⁺)₂O₅, tricalcium aluminate (Ca₃Al₂O₆), calcium aluminates known as monocalcium aluminate (CaAl₂O₄), calcium hexaluminate (CaAl₁₂O₁₈), used individually or as a mixture.

More preferably the hydraulic binder is selected from Portland cement and the aluminous cements.

The said hydraulic binder allows the shaping of the said material in the step b) of the preparation process according to the invention and confers a good mechanical strength on the said material.

In accordance with the invention the said step a) consists in mixing at least one powder for at least one crystalline organic-inorganic hybrid material (COIHM) with at least one powder of at least one hydraulic binder so as to obtain a mixture, the said mixing step being carried out in the absence of solvent.

Thus, the mixture of powders, preferably dry powders, is carried out in the dry state.

According to a variant, at least one source of silica can be mixed in the step a). The said source of silica is advantageously selected from precipitated silica and the silica obtained from by-products such as fly ash, such as for example silico-aluminous or silico-calcium particles and fumed silica.

Preferably the said source of silica is mixed in the form of powder, preferably dry powder.

Preferably the source of silica has a size below 10 μm, and preferably below 5 μm, still more preferably below 1 μm.

Preferably the source of silica is in an amorphous or crystalline form.

Within the context of the invention it is perfectly conceivable to prepare mixtures of several powders of different crystalline organic-inorganic hybrid materials (COIHM) and/or mixtures of powders of different sources of silica and/or mixtures of powders of different hydraulic binders.

According to a variant, at least one organic adjuvant may be mixed in the step a). Preferably the said organic adjuvant is mixed in the form of powder, preferably dry powder. The said organic adjuvant is advantageously selected from cellulose derivatives, polyethylene glycols, aliphatic monocarboxylic acids, alkylated aromatic compounds, sulphonic acid salts, fatty acids, polyvinyl pyrrolidone, polyvinyl alcohol, methyl cellulose, polyacrylates, polymethacrylates, polyisobutene, polytetrahydrofuran, starch, polysaccharide type polymers (such as xanthan gum), scleroglucan, hydroxyethylated celluloses type derivatives, carboxymethylcellulose, lignosulphonates, and galactomannan derivatives, taken individually or as a mixture.

The said organic adjuvant may also be selected from all the additives known to the person skilled in the art.

In the case where at least one source of silica and/or at least one organic adjuvant are also mixed in the course of the step a), the said source of silica and/or the said organic adjuvant are advantageously mixed in the form of powder, preferably dry powder.

The order in which the mixing of the powders of at least one crystalline organic-inorganic hybrid material (COIHM), at least one hydraulic binder, optionally of at least one source of silica and optionally of at least one organic adjuvant in the case where the latter are mixed in the form of powders, is carried out is unimportant.

The mixing of the said powders may advantageously be carried out in a single operation.

The additions of powders may also advantageously be alternated.

Preferably the said mixing step a) is carried out with mixers in batch operation or continuous operation. In the case where the said step a) is carried out in batch operation, the said step a) is advantageously performed in a mixer preferably equipped with Z-shaped arms, or a cam mixer, or in any other type of mixer such as for example a planetary mixer, a screw mixer or a multidirectional powder mixture, or also a V-shaped powder mixture. The said mixing step a) enables a homogenous mixture of the pulverulent constituents to be obtained.

Preferably the said step a) is carried out for a time between 5 and 60 minutes, and preferably between 10 and 50 minutes. The rotational speed of the arms of the mixer is advantageously between 10 and 75 rpm, preferably between 25 and 50 rpm.

Preferably,
1% to 99% by weight, preferably 5% to 99% by weight, preferably 7% to 99% by weight, and most preferably 10% to 95% by weight of at least one powder of at least one crystalline organic-inorganic hybrid material,
1% to 99% by weight, preferably 1% to 90% by weight, preferably 1% to 50% by weight, and most preferably 1% to 20% by weight of at least one powder of at least one hydraulic binder,
0% to 20% by weight, preferably 0% to 15% by weight, preferably 0% to 10% by weight, and most preferably 0% to 5% by weight of at least one source of silica, preferably in the form of powder,
0% to 20% by weight, preferably 1% to 15% by weight, preferably 1% to 10% by weight, and most preferably 1% to 7% by weight of at least one organic adjuvant, preferably in the form of powder,
   are introduced in the step a), the percentages by weight being expressed with respect to the total amount of compounds and preferably of powders introduced in the said step a) and the sum total of the amounts of each of the compounds and preferably of powders introduced in the said step a) being equal to 100%.

### Step b):

In accordance with the invention the said step b) consists in shaping the mixture obtained at the end of the mixing step a).

Preferably the said step b) is advantageously carried out by pelleting in the absence of solvent or by granulation.

According to a first variant the step b) of shaping the mixture obtained at the end of the step a) is carried out by granulation.

In this case the said step b) is advantageously carried out in a granulation apparatus under conditions well known to the person skilled in the art. The said granulation apparatus may be a rotary granulator, a rotating benzel, a rotary bowl or any other device enabling spheres to be formed by granulating at least one powder and at least one liquid, the liquid being sprayed onto the said powder or powders. In the context of the present invention the liquid is sprayed onto the powder mixture obtained at the end of the step a) comprising at least one powder of at least one crystalline organic-inorganic hybrid material, at least one powder of at least one hydraulic binder, optionally at least one source of silica in the form of powder and optionally at least one organic adjuvant in the form of powder. The said liquid is preferably water. It serves to agglomerate the mixture of powders prepared in the step a). Other solvents, such as for example alcohols, may also advantageously be used.

In the said first variant at least one source of silica and/or at least one organic adjuvant may optionally be added during the course of the said shaping step b).

In this case, at least the said source of silica and/or at least the said organic adjuvant may advantageously be added in solution or suspension to the said liquid and are then advantageously sprayed onto the mixture of powders obtained at the end of the step a), in the granulator.

The shaping by granulation allows the formation of spheroidal particles of the said shaped material.

In the case where the said shaping step b) is carried out by granulation, the material obtained is in the form of spheres and in particular in the form of spheres of diameter between 0.3 and 10 mm and preferably more than 2 mm.

According to a second variant, the step b) of shaping the mixture obtained from the step a) is carried out by pelleting in the absence of solvent. Preferably the said step b) of shaping by pelleting is carried out at a pelleting pressure greater than 1 kN and preferably between 2 kN and 20 kN. The geometry of the pelleting die, which gives the pellets their shape, may be selected from dies well known to the person skilled in the art. They may therefore for example be of cylindrical shape. The dimensions of the pellets (diameter and length) are adapted so as to satisfy the demands of the process in which they will be used. Preferably the pellets have a diameter between 0.3 and 10 mm and a diameter to height ratio preferably between 0.25 and 10.

The process of preparing the said material according to the invention may also optionally include a maturation step c) of the shaped material obtained at the end of the step b). The said maturation step is advantageously carried out at a temperature between 0 and 300° C., preferably between 20 and 200° C. and preferably between 20 and 150° C., for a time between 1 minute and 72 hours, preferably between 30 minutes and 48 hours and preferably between 1 hour and 48 hours. Preferably the said maturation step is carried out under air and preferably under moist air with a relative humidity between 20 and 100% and preferably between 70 and 100%. This step allows a good hydration of the material necessary for a complete setting of the hydraulic binder.

The shaped material obtained from the shaping step b) or from the maturation step c) may also optionally undergo a calcination step at a temperature between 50 and 500° C., preferably between 100 and 300° C. for a time between 1 and 6 hours and preferably between 1 and 4 hours.

At the end of the process for preparing the material according to the invention, the material obtained is in the form of spheres or pellets.

Another object of the present invention relates to the material obtained by the preparation process according to the invention. The material obtained by the preparation process according to the invention comprises at least one crystalline organic-inorganic hybrid material (COIHM) shaped by pelleting in the absence of solvent or by granulation with a binding formulation comprising at least one hydraulic binder.

Preferably the said material obtained by the preparation process according to the invention has the following composition:
1% to 99% by weight, preferably 5% to 99% by weight, preferably 7% to 99% by weight, and most preferably 10% to 95% by weight of at least one crystalline organic-inorganic hybrid material,
1% to 99% by weight, preferably 1% to 90% by weight, preferably 1% to 50% by weight, and most preferably 1% to 20% by weight of at least one hydraulic binder,
0% to 20% by weight, preferably 0% to 15% by weight, preferably 0% to 10% by weight, and most preferably 0% to 5% by weight of at least one source of silica,
0% to 20% by weight, preferably 1% to 15% by weight, preferably 1% to 10% by weight, and most preferably 1% to 7% by weight of at least one organic adjuvant, the percentages by weight being expressed with respect to the total weight of the said material and the sum total of the amounts of each of the compounds of the said material being equal to 100%.

The said preparation process according to the invention enables materials to be obtained according to the invention having mechanical strength values measured by grain by grain crushing that are greater than 0.4 daN/mm, preferably greater than 0.9 daN/mm, and preferably greater than 1 daN/mm, regardless of the content of COIHM employed.

These mechanical strength properties are maintained even after a heat treatment at a temperature of up to 300° C. (when the associated crystalline organic-inorganic hybrid material is resistant to these temperatures) and for compositions of materials containing up to 95% by weight of crystalline organic-inorganic hybrid material with respect to the total weight of the said material. In other words, the material obtained by the process according to the invention has a high mechanical strength that is maintained even at a high temperature. Mechanical resistance to lateral crushing is understood to mean the mechanical strength of the material according to the invention determined by the grain by grain crushing test (EGG). This is a standardised test (ASTM D4179-01 standard), which consists of subjecting a material in the form of a millimetre size object, such as a ball or a pellet, to a compression force producing rupture. This test is therefore a measure of the tensile strength of the material. The analysis is repeated on a specific number of solids taken individually and typically on a number of solids between 10 and 200. The mean value of the measured lateral rupture forces represents the mean EGG, which is expressed in the case of granules in unit of force (N), and in the case of extrudates in unit of force per unit length (daN/mm or decaNewton per millimetre of length of extrudate).

The said materials obtained by the preparation process according to the invention have enhanced mechanical properties, particularly in terms of mechanical strength, regardless of the content of crystalline organic-inorganic hybrid material (COIHM) employed, and are resistant to a rise in temperature, which allows for the use of the said material in processes in the presence of water or solvents and at relatively high temperatures but which are nevertheless restricted by the temperature behaviour of the crystalline organic-inorganic hybrid material (COIHM). The material obtained at the end of the preparation process according to the invention may therefore be used for applications in catalysis, separation, purification, capture, etc.

The said material obtained by the preparation process according to the invention may be contacted with the gaseous feed to be treated in a reactor, which may either be a fixed bed reactor or a radial reactor, or also a fluidised bed reactor.

The following examples illustrate the invention without however restricting its scope.

### EXAMPLES

So as to illustrate the invention, several preparation methods are described, based on shaping a crystalline organic-inorganic hybrid material (COIHM), in particular ZIF-8, commercially available under the name Basolite Z1200 (Sigma Aldrich).

### Example 1

### Comparative

The ZIF-8 powder is pelleted using a MTS compression machine provided with pressure and displacement instruments and equipped with a system consisting of a die and punches and providing for the production of compacts. The diameter of the device selected for these tests is 4 mm. The die is fed with the ZIF-8 powder and a force of 7 kN is applied to the system.

The compacts obtained have the following characteristics: S_{BET}=1340 m²/g, EGG=0.7 daN/mm.

An analysis of these compacts by X-ray diffraction shows a loss of crystallinity produced by this shaping method, which is also reflected in a reduction of the specific surface area (which was 1430 m²/g for the Basolite Z1200 powder). The pellets readily dissolve on contact with a solvent (tests carried out with water and ethanol).

### Example 2

### Process for Preparing a COIHM Formed by Pelleting in the Absence of Solvent According to the Invention

The powders of ZIF-8 (90 wt. %), of Portland cement (Black label produced by Dyckerhoff) (5%) and of methocel (K15M) (5%) are introduced and premixed in a Brabender mixer for 15 minutes. The mixture obtained is pelleted using a MTS compression machine provided with pressure and displacement instruments and equipped with a system consisting of a die and punches and allowing the production of compacts. The diameter of the device chosen for these tests is 4 mm. A force of 5 kN is applied to the system. The material shaped by pelleting then undergoes a maturation step at a temperature of 20° C. for 4 days, under moist air containing 100 wt. % of water. The compacts obtained have the following characteristics: S_{BET}=1150 m²/g, EGG=1 daN/mm.

### Example 3

### Process for Preparing a COIHM Formed by Granulation According to the Invention

The powders of ZIF-8 (90 wt. %), of Portland cement (Black label produced by Dyckerhoff) (5%) and of methocel (K15M) (5%) are introduced and premixed in a benzel for 15 minutes. Water is sprayed in the form of very fine droplets onto the mixture so as to obtain spherical objects 3 mm in diameter. The shaped material then undergoes a maturation step at a temperature of 20° C. for 4 days, under moist air containing 100 wt. % of water. The granules obtained have the following characteristics: S_{BET}=1300 m²/g, EGG=1.2 daN.

### Example 4

### Process for Preparing a COIHM Formed by Granulation According to the Invention

The powders of ZIF-8 (85% wt. %), of Portland cement (Black label produced by Dyckerhoff) (10%) are introduced and premixed in a benzel for 15 minutes. A colloidal suspension of silica in water is sprayed in the form of very fine droplets onto the mixture in order to obtain spherical objects 3 mm in diameter. The shaped material then undergoes a maturation step at a temperature of 20° C. for 4 days, under moist air containing 100 wt. % of water. The granules obtained have the following characteristics: S_{BET}=1200 m²/g, EGG=1.3 daN.

### Example 5

### Process for Preparing a COIHM Formed by Granulation According to the Invention

The powders of ZIF-8 (85% wt. %) and of Portland cement (Black label produced by Dyckerhoff) (10%) are introduced and premixed in a benzel for 15 minutes. A solution of methocel (K15M) in water is sprayed in the form of very fine droplets onto the mixture so as to obtain spherical objects 4 mm in diameter. The shaped material then undergoes a maturation step at a temperature of 20° C. for 4 days, under moist air containing 100 wt. % of water. The granules obtained have the following characteristics: S_{BET}=1200 m²/g, EGG=1.2 daN.

1. Process for preparing a material comprising at least the following steps:
a) a step of mixing at least one powder of at least one crystalline organic-inorganic hybrid material with at least one powder of at least one hydraulic binder in order to obtain a mixture, the said mixing step being carried out in the absence of solvent;
b) a step of shaping the mixture obtained at the end of the step a).

2. Preparation process according to claim 1, in which the said crystalline organic-inorganic hybrid material is preferably selected from MOF, ZIFs, MILs and IRMOFs, individually or as a mixture.

3. Preparation process according to claim 1, in which the said hydraulic binder is selected from Portland cement, aluminous cements, sulfo-aluminous cements, plaster, cement containing phosphate bonds, blast furnace slag cements and mineral phases selected from alite (Ca₃SiO₅), belite (Ca₂SiO₄), alumino-ferrite (or brownmillerite: semi-formula Ca₂(Al,Fe³⁺)₂O₅), tricalcium aluminate (Ca₃Al₂O₆), calcium aluminates such as monocalcium aluminate (CaAl₂O₄), calcium hexaluminate (CaAl₁₂O₁₈), used individually or as a mixture.

4. Preparation process according to claim 3, in which the hydraulic binder is selected from Portland cement and aluminous cements.

5. Preparation process according to claim 1, in which at least one source of silica is mixed in the step a).

6. Preparation process according to claim 1, in which at least one organic adjuvant is mixed in the step a).

7. Preparation process according to claim 6, in which the said organic adjuvant is selected from cellulose derivatives, polyethylene glycols, aliphatic monocarboxylic acids, alkylated aromatic compounds, sulphonic acid salts, fatty acids, polyvinyl pyrrolidone, polyvinyl alcohol, methylcellulose, polyacrylates, polymethacrylates, polyisobutene, polytetrahydrofuran, starch, polysaccharide type polymers, scleroglucan, hydroxyethylated celluloses type derivatives, carboxymethylcellulose, lignosulphonates, and derivatives of galactomannan, used individually or as a mixture.

8. Preparation process according to claim 1, in which
1% to 99 wt. % of at least one powder of at least one crystalline organic-inorganic hybrid material (COIHM),
1% to 99 wt. % of at least one powder of at least one hydraulic binder,
0% to 20 wt. % of at least one source of silica,
0% to 20 wt. % of at least one organic adjuvant,
are introduced in the step a), the weight percentages being expressed with respect to the total amount of compounds introduced in the said step a) and the sum total of the amounts of each of the compounds introduced in the said step a) being equal to 100%.

9. Preparation process according to claim 8, in which
10% to 95 wt. % of at least one crystalline organic-inorganic hybrid material,
1% to 20 wt. % of at least one hydraulic binder,
0% to 5 wt. % of at least one source of silica,
1% to 7 wt. % of at least one organic adjuvant,
are introduced in the step a), the weight percentages being expressed with respect to the total amount of compounds introduced in the said step a) and the sum total of the amounts of each of the compounds introduced in the said step a) being equal to 100%.

10. Preparation process according to claim 9, in which the said step b) is carried out by pelleting in the absence of solvent or by granulation.

11. Preparation process according to claim 1, in which the said preparation process also comprises a maturation step c) of the shaped material obtained at the end of the step b), the said maturation step being carried out at a temperature between 0 and 300° C., for a time between 1 hour and 48 hours.

12. Preparation process according to claim 11, in which the said maturation step is carried out under air and preferably under moist air containing between 20 and 100 wt. % of water.

13. Preparation process according to claim 1, in which the said preparation process also comprises a calcination step d) at a temperature between 50 and 500° C., for a time between 1 and 6 hours.
